(19) United States
(12) Patent Application Publication
(10) Pub. No.: US 2004/0043805 A1
(43) Pub. Date: Mar. 4, 2004

(54) Gaming machine and program for implementing the game

(76) Inventor: Shuji Sonoda, Machida (JP)

Correspondence Address: OLIFF & BERRIDGE, PLC, P.O. BOX 19928, ALEXANDRIA, VA, 22320, US

(21) Appl. No.: 10/233,418

(22) Filed: Sep. 4, 2002

(30) Foreign Application Priority Data
Jul. 31, 2002 (JP) 2002-222514

(51) Int. Cl. A63F 13/00

(52) U.S. Cl. 463/1

(57) ABSTRACT

There is implemented a game which enables provision of diversity to contents of the game. Data described in a hypertext or markup language are acquired by acquisition means over the Internet. The acquisition means passes the thus-acquired data described in hypertext or markup language to syntactic analysis means. The syntactic analysis means performs syntactic analysis operation and outputs a result of the analysis as game elements. Gaming means executes a game using the game elements. Consequently, contents of a game vary according to contents of the hypertext data, thus enabling implementation of a game involving a full range of diversity.

### BACKGROUND OF THE INVENTION

1. Field of the Invention

The invention relates to a gaming machine. Particularly, the invention relates to a gaming machine called a computer game.

2. Related Art

Heretofore, various games have been widely utilized and enjoyed as affordable entertainment.

In particular, a device called a computer gaming machine enables a player to enjoy a plurality of types of games by means of switching of programs and hence has become widely pervasive as a home gaming appliance.

The majority of currently available computer games are embodied by means of causing a gaming machine main unit to run a program having game contents described therein. In the case of a home gaming machine, a program is often supplied in the form of a recording medium, such as a CD-ROM or DVD-ROM. The gaming machine main unit runs contents of, for example, a CD-ROM, thereby enabling a player to play games.

Since a related-art computer game adopts such a configuration, contents of a game are in principle limited to those recorded on a recording medium.

An attempt has been made to impart diversity to a game by means of parameters. However, this intends to induce changes in the player's action or changes in game settings, such as scores, on the basis of predetermined random numbers. Thus, limits are imposed on the diversity of a game world.

In the field of other types of games, such as so-called net games, there has already been known a game which enables a player to play a battle game with another player (or other players) over a network. However, such a network game is characterized by only an increase in the number of players and fails to enrich contents of the game.

### SUMMARY OF THE INVENTION

Accordingly, the invention has been conceived in view of the foregoing circumstances and aims at implementing a game which renders contents thereof diverse.

In order to solve the problem, the invention provides a gaming machine comprising:

syntactical analysis means for subjecting data described in a hypertext or markup language to syntactic analysis and for outputting game elements as a result of interpretation; and

gaming means for executing a game on the basis of the game elements.

By means of such a configuration, a change can be brought into a game by hypertext data or the like.

Preferably, the gaming machine further comprises:

acquisition means which acquires data described in hypertext or markup language, byway of a communications network, and supplies the thus-acquired data described in hypertext or markup language to the syntactic analysis means.

By means of such a configuration, a change can be brought into a game on the basis of hypertext data or the like available on a network.

Preferably, the acquisition means acquires the data described in hypertext or markup language from an address entered by the user or an address supplied from the outside.

By means of such a configuration, the gaming machine can ascertain the location of hypertext data or the like. Here, for example, a URL or the like is preferable as an address.

Preferably, the described data include at least one of a tag, a parameter for the tag, a text, and data pertaining to objects to be linked.

By means of such a configuration, an arrangement for setting game elements by use of a tag or the like is obtained.

The invention also provides a program for causing a computer to act as a gaming machine, wherein

the computer executes syntactic analysis procedures which are to be used for subjecting data described in hypertext or markup language to syntactic analysis and for outputting game elements as a result of analysis; and

game procedures for executing a game on the basis of the game elements.

By means of such a configuration, a change can be brought into a game by hypertext data or the like.

Preferably, the computer is caused to execute acquisition procedures which enable acquisition of data described in either hypertext or markup language by way of a communication network and supply of the data described in hypertext or markup language to the syntactic analysis means.

By means of such a configuration, a change can be brought into a game on the basis of hypertext data or the like available on a network.

Preferably, the acquisition procedures are for acquiring the data described in hypertext or markup language from an address entered by the user or from the outside.

By means of such a configuration, the gaming machine can ascertain the location of hypertext data or the like. Here, for example, a URL or the like is preferable as an address.

Preferably, the described data include at least one of a tag, a parameter for the tag, a text, and data pertaining to objects to be linked.

By means of such a configuration, an arrangement for setting game elements by use of a tag or the like is obtained.

The invention also provides a game service method utilizing the gaming machine set forth, comprising:

a step of providing, to a user of the gaming machine or to the gaming machine, an address indicating presence of the data described in hypertext or markup language for determining game elements.

By means of such a service configuration, the user can readily ascertain an address of hypertext data or the like to be used for setting game elements.

The invention also provides a game service method utilizing the program set forth, comprising:

a step of providing, to a computer which runs the program or to a user which causes a computer to run the program, an address indicating presence of the data described in hypertext or markup language for determining game elements.

By means of such a service configuration, the user can readily ascertain an address of hypertext data or the like to be used for setting game elements.

### BRIEF DESCRIPTION OF THE DRAWINGS

In the accompanying drawings,

FIG. 1 is a conceptual rendering of a preferable gaming machine according to the invention;

FIGS. 2-1 and 2-2 are descriptive views showing a screen of a shooting game according to an embodiment of the invention; and

FIG. 3 is a descriptive view showing a screen of a role-playing game of the embodiment.

### DESCRIPTION OF THE PREFERRED EMBODIMENT

A preferred embodiment of the invention will be described hereinbelow by reference to the accompanying drawings.

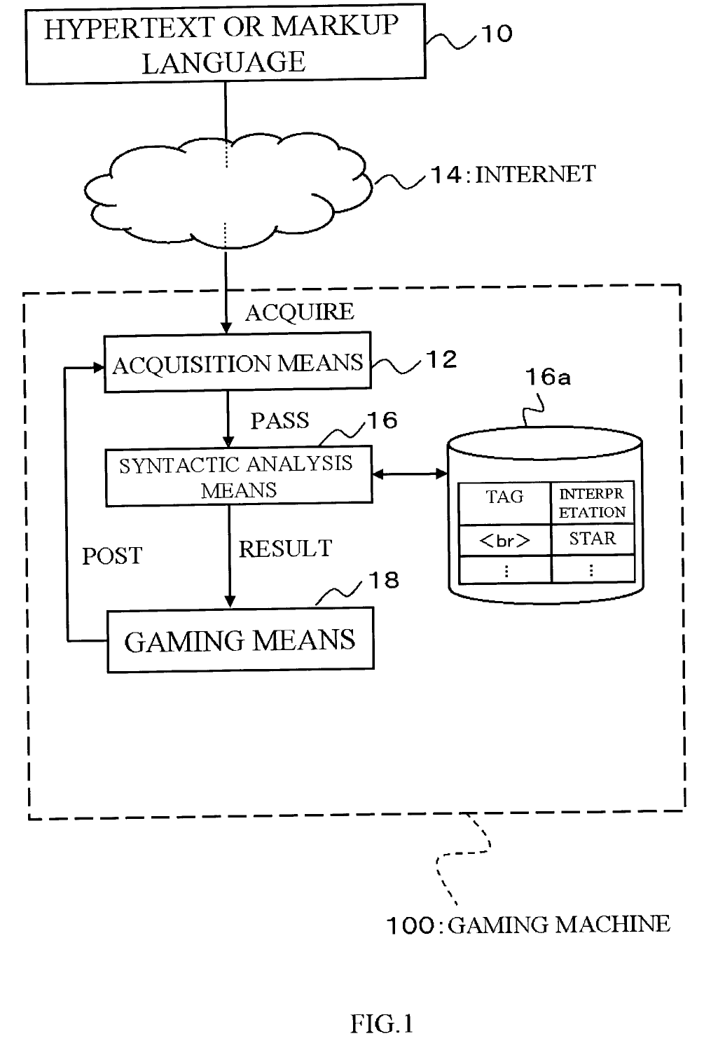

FIG. 1 is a conceptual rendering showing a preferred embodiment of the invention. As illustrated, acquisition means 12 acquires data described in a hypertext or a markup language 10, by way of the Internet 14. The acquisition means 12 passes the thus-acquired data described in hypertext or markup language 10 to syntactic analysis means 16, and the syntactic analysis means 16 executes syntactic analysis operation.

The embodiment is characterized in that the syntactic analysis means 16 subjects the data described in hypertext or markup language 10 to syntactic analysis, whereby game elements are output as a result of analysis. Gaming means 18 executes a game through use of the thus-produced game elements.

The acquisition means 12, the syntactic analysis means 16, and the gaming means 18 are embodied as programs which run on a computer. In the embodiment, a computer having the acquisition means 12, the syntactic analysis means 16, and the gaming means 18 installed there in is called a gaming machine 100. A syntactic analysis routine to be used by the syntactic analysis means 16 is stored in a hard disk drive 16a.

Data stored in a server (a so-called WEB server) located on the world-wide web (WWW) can be typically used as the data described in the hypertext or markup language 10. The server uses a protocol called hypertext transfer protocol (http). A location where the data described in the hypertext or markup language 10 are stored is generally specified by a symbol defining an address called a universal resource locator (URL) and an access method (i.e., a protocol or the like). The data described in hypertext or markup language 10 are now present everywhere on the Internet 12 and sufficiently available.

Therefore, a URL corresponds to an example of an address stated in the appended claims.

The acquisition means 12 acquires the data described in the hypertext or markup language 10 by way of the Internet 14. Such means has hitherto been known and can be sufficiently implemented in the related art.

The syntactic analysis means 16 subjects the hypertext or markup language 10 to syntactic analysis. Syntactic analysis operation per se has already been included in, e.g., a conventional WEB browser or the like.

The embodiment is characterized in that interpretation yielded by the syntactic analysis differs from formal interpretation. In the embodiment, contents of the hypertext or markup language 10 are used as data for rendering game elements diverse. To this end, in the embodiment, interpretation is executed not as formal interpretation but as game elements. Consequently, in the embodiment, the syntactic analysis rules stored in the hard disk drive 16 a totally differ from a related-art WEB browser. The nature of an interpretation rule and a specific example thereof will be described in detail later. Here, the term “game elements” is a generic name for various objects emerging in a game, a game environment, events arising in a game, or the like. Specific examples of game elements will also be described in detail later.

The gaming means 18 is embodied as a so-called program of a computer game. Here, computer games have hitherto been well known and are sufficiently practicable. The gaming means 18 of the embodiment is characterized in that settings of game elements are received from the syntactic analysis means 16. In the case of a related-art computer game program, settings of various game elements have already been fixed to a certain extent. The program is provided with a random characteristic through use of random numbers, or operation of the program is varied slightly in accordance with the input status of a user. However, a game whose configuration is basically changed in a random manner has never existed.

In the embodiment, a game is made diverse as a result of receipt of settings of game elements from the outside. This is unprecedented and novel.

Specific operation of the embodiment will be described hereinbelow by means of taking a shooting game and a role-playing game as examples.

A. Shooting Game

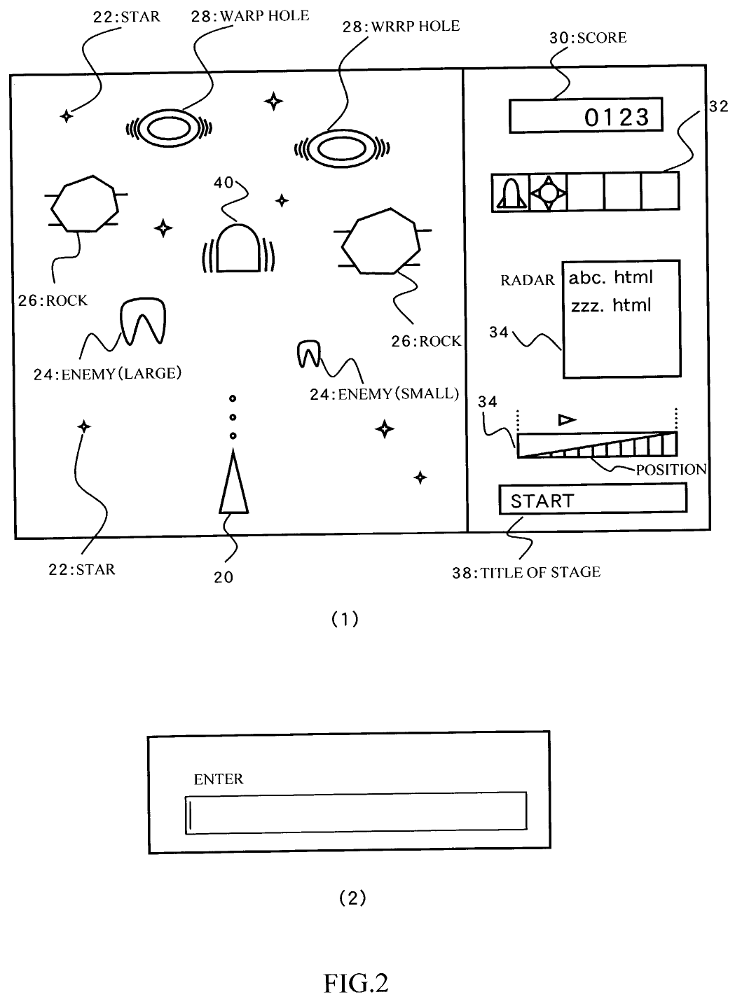

FIG. 2-1 shows the configuration of a screen pertaining to a shooting game according to the embodiment. As illustrated, displayed on the screen of the shooting game are a main character 20 which performs shooting action (often assumes the form of a fighter plane); enemies (targets); various obstacles; items which involve occurrence of events; and other objects. Displayed on the screen are a star 22, enemies 24 which serve as targets, rocks 26 serving as obstacles, and warp holes 28. Further, a post pole 40 also appears on the screen.

The user defeats the enemies 24 by means of shooting while manipulating the main character 20.

As shown in FIG. 2-1, a score 30 and an available weapon list 32 are disposed on the right-hand side of the screen. Further, a radar 34 display is displayed on the right-hand side of the screen, thereby indicating URLs of WEB pages which have been used as the sources for the stages cleared by the user. The radar display 34 will be described in detail later.

A position indicator showing the location of the main character 20 on the current stage is shown on the right-hand side of the screen. Further, the title of the stage is displayed in a lower right section of the screen.

The embodiment is characterized in that various objects or events appearing on the screen are set on the basis of the external data described in HTML (hypertext markup language). In the embodiment, a tag provided in an HTML is interpreted as follows. A screen of a shooting game is constituted by supplying interpretation of the tag to the gaming means 18, thus generating various events.

Various examples of interpretation of HTML data are provided below.

a-1. Interpretation of a Tag

<br> signifies the star 22 provided on the background of outer space. Here, the star 22 is an example of a game element.

<a href> originally signifies a link but also means the warp hole 28, which enables a jump to another stage during the course of the shooting game. Here, the warp hole is an example of a game element. Upon touching the warp hole 28, the main character 20 proceeds to another stage as having cleared the current stage. As a result, the user can continue playing games on another stage. Another stage, which is a destination of the user, is constituted of HTML data pertaining to stages linked by the tag <a href>.

<title> signifies the title 38 of the current stage. As shown in FIGS. 2-1 and 2-2, the title is displayed at the lower right section of the screen. This title is also an example of a game element.

<BackGroundColor> originally signifies the color of a background but also means the background of the game screen in the embodiment. By means of the tag, the background color of the game screen is determined. Here, the background color to be used here does not need to be a color instructed by the tag. The original color may be converted according to a given rule. The rule of conversion is also stored in the hard disk drive 16a as a syntactic analysis rule. Here, the background color is also an example of a game element.

A tag to be used for referring to an image, such as <img src=>, signifies the rock 26 whose image is used as a texture. As a result, the pattern of the rock 26 is changed in accordance with details of the HTML text, thereby constituting an interesting screen. Such a rock 26 and the texture thereof are also examples of game elements.

A tag, such as <H1>, represents the size of caption characters. In the embodiment, the tag shows the enemy 24; that is, an object of shooting. Here, a numeral appended to letter H represents the size of the enemy 24. For instance, in the case of H1, the enemy 24 has a size equal to numeral 1. In the case of H6, an enemy 24 of size equal to numeral 6 appears on the screen. Here, a color for the portion enclosed by <H1> </H1> is sometimes specified. In this case, the thus-specified color is preferably taken as the color of the enemy 24. By means of such settings, the configuration of the shooting game screen is determined by information included in the HTML text. Hence, a game involving a different screen configuration can be enjoyed by selection of an HTML text to be utilized at the current time. As a matter of course, even in this case, the color may be converted on the basis of a predetermined conversion rule. The size and color of the enemy 24 are examples of game elements.

</HTML> originally means the end of the HTML text. In the embodiment, the tag also means the end of one stage. As a result, one HTML text represents one “stage” in the shooting game. Consequently, the length of the stage may vary, depending on the length of a utilized HTML. There can be realized a game whose stage length varies every time a game is executed. Such a length of a stage is also an example of a game element.

a-2 Text

In a case where a certain character string appears in text data included in an HTML string, the character string may preferably be interpreted as an enemy or an obstacle, as in the case of the tags. Further, when a certain character string has appeared, a bonus stage is preferably configured so as to be forcefully started. Alternatively, a special bonus point may preferably be added to a score when a certain character string has appeared. Any character string may be used as a certain character string. For instance, a “wonder witch,” a “tomato,” or an “automobile” may be used. Occurrence of such an obstacle or bonus stage is also an example of a game element. The character string is also an example of a game element.

Depending on the configuration of a game, there may be configured a game in which players compete against each other for appearance of a certain character string. For instance, a player continues shooting action until a character string “CUTE” appears. The players compete against each other for a higher score until the character string “CUTE” has been found. Such a word “CUTE” is also an example of a game element.

a-3 Music Data

When an HTML includes sound data, such as MIDI, the music is preferably used as sound for a game; that is, background music (BGM). Such music is also an example of a game element.

a-4 Operation of the Post Pole 40

HTML data sometimes include a tag for prompting the user to perform an input operation. The post pole 40 is a result of interpretation of such a tag. When the post pole 40 is shot, an input dialogue, such as that shown in FIG. 2-2, appears on the screen, thereby enabling the user to enter an arbitrary input. The thus-entered value is supplied from the gaming means 18 to the acquisition means 12. The acquisition means 12 transmits the value to the WEB server which offers the hypertext or markup language 10. Here, such an operation corresponds to an instruction called “post” in the protocol HTTP. When such a value is input, the WEB server usually transmits new HTML data. Hence, there is yielded an advantage of the user being able to forcefully change the game screen, thereby rendering the game more interesting. For instance, a keyword input field in a search engine serves as a WEB screen which enables the user to perform an input operation. Here, the post pole 40 is also an example of a game element.

a-5 Display Sequence

A sequence in which objects (such as the enemies 24 and the warp holes 28) appear is the same as that in which HTML strings to be utilized appear. In other words, text of an HTML string is interpreted from the beginning, and the enemy 24, the rock 26, and the warp hole 28 appear in that sequence of interpretation.

B. Role-Playing Game

In the shooting game, one HTML string represents one stage. However, in the role-playing game, one HTML string preferably means one town or the like.

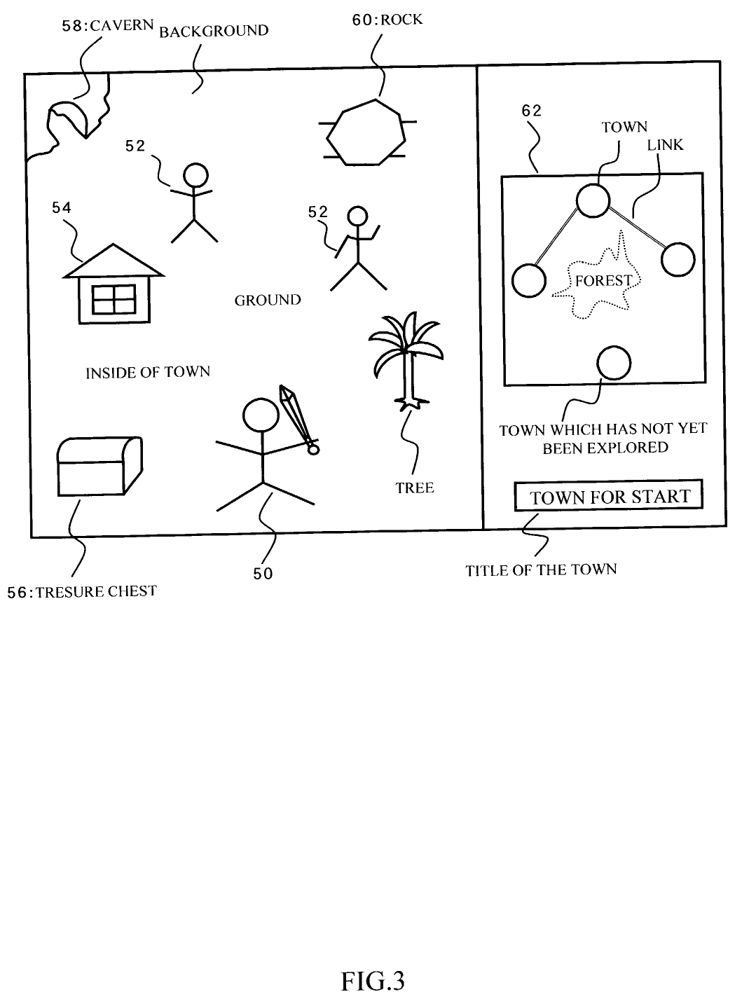

FIG. 3 shows a screen configuration of a role-playing game of the embodiment. As illustrated, the screen of a role-playing game is constituted of a main character 50 who is an explorer, townspeople who have conversations with the main character 50, various remains, and constructions such as houses 54. As shown in FIG. 3, a treasure chest 56, a cavern 58, a rock 60, and natural objects such as trees are displayed on the screen.

In the role-playing game, an entire map 62 showing a plurality of towns where the main character 50 has explored is displayed on the right-hand side of the screen. As shown in FIG. 3, towns (other HTML data liked by the current HTML data) linked to a current town (a town represented by the current HTML data) are shown on the entire map. In particular, roads are displayed so as to interlink the towns where the main character 50 has already explored, thus showing that the thus-linked towns have already been explored (visited). In contrast, towns where the main character 50 has not yet visited (explored) are not provided with roads.

The embodiment is characterized in that various persons 52 and constructions, such as houses 54, appearing on the screen are set on the basis of the data described in HTML.

Even in the embodiment, a background color or the like is set on the basis of HTML data in basically the same manner as in the case of the shooting game. In the shooting game, the enemies 24 or the like are set on the basis of HTML data. However, in the role-playing game, HTML data are used for setting the persons 52 who meet and talk with the main character 50.

In particular, in the case of a role-playing game, a tag included in HTML should preferably be interpreted as follows:

An example of a tag will be provided below.

1-1 Interpretation of a Tag

<a href> originally signifies a link, but also means the cavern 58, which is used for jumping to another town during the role-playing game. Upon entry into the cavern 58, the main character 50 can jump to another town. As a result, the user can continue playing games in another town. The configuration of a target town is configured by utilization of HTML data linked by the tag <a href>. In this way, in the embodiment, one town is set by one HTML data set. If a target of link is the same site, display of inside of the cavern 58 instead of display of another town is preferable. In this case, a game proceeds to an exploration of the inside of the cavern 58, thereby displaying a map showing the inside of the cavern 58.

Such a cavern 58 and a destination of a jump are examples of game elements.

<table> originally signifies a table. In the embodiment, however, this tag signifies the structure of a construction (the house 54). For instance, the number of rows preferably means the number of floors of the house 54, and the number of columns preferably means the number of rooms existing on one floor. Preferably, details of a table represent items available in a room. The house 54 is an example of a game element, and the number of rooms per floor is also an example of a game element.

Here, <table> may signify the treasure chest 56. Details of the table are interpreted as contents of the treasure chest 56. As a result, the contents of the treasure chest 56 are changed, depending on the contents of HTML data, whereby a more interesting game is implemented. The treasure chest 56 is an example of a game element.

<title> means a title of the town. The designation of the title is displayed on a screen; for example, the right-hand side of the screen, for the user. The title of the town is also an example of a game element.

<BackGroundColor> originally signifies the color of a background, but in the embodiment also means the background of the game screen. By means of the tag, the background color of the game screen is determined. As a matter of course, conversion of the original color according to a given rule rather than a color instructed by the tag being used as instructed is an interesting feature. Here, the background color is also an example of a game element.

In the embodiment, tag <img src=>, meaning reference to an image, signifies natural objects such as the rock 60 for which an image is used as a texture. As a result, the pattern of the rock 60 on the map changes depending on HTML data utilized. Thus, a more interesting game can be implemented. Such a rock 60 and the texture thereof are examples of game elements.

Tag <H1> signifies the size of a caption letter. In the embodiment, the tag means persons 52 who meet and have a conversation with the main character. Here, a numeral appended to letter H represents the power of the person 52. For instance, in the case of H1, a small person having a size of 1 appears. In the case of H6, a giant appears on the screen. Here, a color for the portion enclosed by <H1> </H1> is sometimes specified. In this case, the thus-specified color is preferably taken as the color of the person 52. By means of such settings, characters in the role-playing games are determined by information included in the HTML text. Hence, a different person 52 appears each time by utilization of different HTML data, whereby the player can enjoy a game involving a variety of changes. Here, the person 52 and the power and color thereof are also examples of game elements.

</HTML> originally means the end of the HTML text. In the embodiment, the tag also means the end of one town. As a result, one HTML text represents (a map of) one “town” in the role-playing game. Consequently, the size of the town may vary, depending on the length of utilized HTML data. There can be implemented an interesting game whose size varies every time a game is executed. A town and the size thereof are also examples of game elements.

b-2 Text

In a case where a certain character string appears in text data included in an HTML string, the character string may preferably be interpreted as the person 52 or an obstacle (e.g., the rock 60), as in the case of the tags. Further, the character string may preferably be interpreted as monsters or animals. The monsters or animals are examples of game elements.

Further, when a certain character string has appeared, a bonus stage is preferably configured so as to be forcefully started. Alternatively, a special bonus point may preferably be added to a score when a certain character string has appeared. Any character string may be used as a certain character string. For instance, a “wonder witch,” a “tomato,” or an “automobile” may be used. Occurrence of such an obstacle or bonus stage is also an example of a game element. The character string is also an example of a game element.

Depending on the configuration of a game, there may be configured a game in which players compete against each other for appearance of a certain character string. For instance, a player continues playing a role-playing game until a character string “CUTE” appears. The players compete against each other for a higher score until the character string “CUTE” has been found. Such a word “CUTE” is also an example of a game element.

b-3 Music Data

When an HTML includes sound data, such as MIDI, the music is preferably used as sound for a game; that is, background music (BGM). Such music is also an example of a game element.

b-4 Display Sequence

A sequence in which the persons 52 and constructions, such as the houses 54 or the like, appear is the same as that in which HTML strings to be utilized appear. Typically, there is conceived an arrangement of providing persons and constructions on both sides of a road in the manner of street stalls opened on the day of a festival in the sequence in which they appear on the HTML string. As a matter of course, a map may be configured while such a sequence is ignored and such that the persons 52 and the houses 54 are arranged randomly on the map (i.e., the configuration of a town). Such display sequence is also an example of a game element.

C. Modifications

(1) Although examples of HTML have been illustrated in above, another hypertext language may also be employed. Here, hypertext means a text having at least a link structure. A typical hypertext is a group of languages which are called markup languages. For example, an SGML language and an XML language, as well as the HTML, are included in the group of markup languages. In addition to the markup languages, a programming language having a link structure, which is called a “hypercard,” is known. The language can constitute a hypertext. A text described in such a language is a hypertext.

(2) Not all the contents of a game need to be determined by HTML data or the like. For instance, in a shooting game, only settings of the enemies (objects) may be extracted from HTML, and other settings may be preferably made identical with those of an existing game.

(3) A case where HTML is acquired by way of the Internet 14 has been described above. However, locally-stored HTML may also be utilized. For example, HTML stored in the hard disk drive 16a of a computer, can also be utilized. By means of such a configuration, the acquisition means 12 is not always needed. The syntactic analysis means 16 may preferably be configured to read HTML directly from the hard disk drive 16a.

HTML located in a so-called LAN may also be utilized.

(4) The acquisition means 12 employed in the embodiment is substantially analogous in function to a so-called related-art WEB browser. Consequently, a WEB browser having a game function may be preferably configured by incorporation of a new syntactic analysis means 16 and gaming means 18 of the embodiment.

(5) The shooting game and the role-playing game are described above. However, any game may be employed, so long as making the game diverse is preferable.

D. Diversity

As has been mentioned, in the embodiment, a game possessing abundant diversity can be implemented by utilization of HTML data on the Internet. Diversity is provided in terms of two points.

First, a game of another setting can be implemented by means of the user modifying a URL to be utilized.

Second, data on the Internet are changed dynamically at all times. Accordingly, even when the same URL is utilized, contents of a game may differ day to day. For instance, contents of a bulletin board are changed daily by means of posting of new messages and deletion of old messages. If such a bulletin board is used, a game whose contents differ each time a game is executed can be enjoyed.

By virtue of these two points, according to the embodiment, a game having abundant diversity and a higher entertainment value can be realized.

E. Operation

(1) Although in the embodiment a URL to be utilized is entered by the user, a program may randomly generate a URL, and the user may play a game using such a random URL. By means of such a configuration, settings are changed every time a game is executed, whereby the user can enjoy a game with various changes.

(2) In the embodiment, a URL to be utilized is entered by the user. However, a game company may provide URLs where data describing game settings are stored, by way of the Internet. For instance, a game company may constitute a portal site in which various game settings are described, and a user accesses the portal site, thereby enjoying a variety of games. As a matter of course, provision of a URL may be transmitted to users by way of other magazines.

As has been described, according to the invention, setting of game elements can be performed on the basis of a hypertext, thereby imparting a full range of variety to a game. Consequently, a game having a full range of diversity can be realized.

According to the service of the invention, the user can ascertain the position of hypertext data, thereby enabling ascertainment of interesting game settings.

What is claimed is:

1. A gaming machine comprising:
syntactical analysis means for subjecting data described in a hypertext or markup language to syntactic analysis and outputs game elements as a result of interpretation; and
gaming means for executing a game on the basis of the game elements.

2. The gaming machine according to claim 1, further comprising:
acquisition means which acquires data described in hypertext or markup language by way of a communications network and supplies the thus-acquired data described in hypertext or markup language to the syntactic analysis means.

3. The gaming machine according to claim 2, wherein the acquisition means acquires the data described in hypertext or markup language from the address entered by the user or the address supplied from the outside.

4. The gaming machine according to claim 1, wherein the described data include at least one of a tag, a parameter for the tag, a text, and data pertaining to objects to be linked.

5. A program for causing a computer to act as a gaming machine, wherein
the computer includes syntactic analysis procedures which are to be used for subjecting data described in hypertext or markup language to syntactic analysis and for outputting game elements as a result of analysis; and
game procedures for executing a game on the basis of the game elements.

6. The program according to claim 5, wherein the computer is caused to execute acquisition procedures which enable acquisition of data described in either hypertext or markup language by way of a communication network and supply of the data described in, hypertext or markup language to the syntactic analysis means.

7. The program according to claim 6, wherein the acquisition procedures are for acquiring the data described in hypertext or markup language from an address offered from the address entered by the user or from the outside.

8. The program according to claim 5, wherein the described data include at least one of a tag, a parameter for the tag, a text, and data pertaining to objects to be linked.

9. A game service method utilizing the gaming machine of claim 3, comprising:
a step of providing, to a user of the gaming machine or to the gaming machine, an address indicating presence of the data described in hypertext or markup language for determining game elements.

10. A game service method utilizing the program of claim 7, comprising:
a step of providing, to a computer which runs the program or to a user who causes a computer to run the program, an address indicating presence of the data described in hypertext or markup language for determining game elements.
